(19) United States
(12) Patent Application Publication
(10) Pub. No.: US 2026/0039196 A1
(43) Pub. Date: Feb. 5, 2026

(54) MULTIPHASE POWER CONVERTER CONTROLLER

(71) Applicant: Texas Instruments Incorporated, Dallas, TX (US)

(72) Inventors: Brent McDonald, MURPHY, TX (US); Sheng-Yang Yu, FRISCO, TX (US)

(21) Appl. No.: 19/223,045

(22) Filed: May 30, 2025

Related U.S. Application Data
(60) Provisional application No. 63/678,094, filed on Aug. 1, 2024.
(60) Provisional application No. 63/678,089, filed on Aug. 1, 2024.

(51) Int. Cl. H02M 3/157; H02M 3/158

(52) U.S. Cl. CPC H02M 3/157; H02M 3/158

(57) ABSTRACT

In described examples, a device includes first and second inductors, first and second phase switching circuits, a proportional-integral (PI) compensator, and a controller. The first and second phase switching circuits are respectively coupled to the first and second inductors. The controller is coupled to the first and second phase switching circuits and the PI compensator. The controller performs the following actions. It generates a phase error signal responsive to a phase difference between first and second control signals respectively corresponding to the first and second phase switching circuits, a switching period, and a target phase delay between the first and second control signals. It provides the phase error signal to the PI compensator. And it controls the first and second phase switching circuits in a first phase and a second phase, respectively, responsive to the first and second control signals and a PI compensator output signal.

### CROSS-REFERENCE TO RELATED APPLICATIONS

This application claims the benefit of, and priority to, U.S. Provisional Pat. App. Nos. 63/678,089 and 63/678,094, each filed Aug. 1, 2024, and each incorporated herein by reference in its entirety.

### TECHNICAL FIELD

This application relates generally to pulse width modulation (PWM) control of power converters, and more particularly to PWM control of multiple phase power converters.

### BACKGROUND

In some examples, a PWM signal is used to control a switched device such as a power converter. One power converter example is a zero voltage switching quasi-square wave (ZVS-QSW) converter, which enables efficient (low loss) provision of power. Some example ZVS-QSW converters are boost converters. A boost converter increases voltage, while decreasing current, from its input to its output. Example applications for power converters include server, telecom, automotive, industrial, and other power supply contexts.

Some applications, such as certain high-power applications, utilize multiphase interleaved converters. In some examples, multiphase converters use multiple different-phase circuits coupled to corresponding primary energy storage devices such as inductors. Control signals of the different-phase circuits are phase-shifted with respect to each other. In some example interleaved converters, there is a fixed-phase relationship between the different phases under the operating frequency (or frequencies). A departure from the intended or specified fixed-phase relationship, particularly if prolonged, may cause converter inefficiency or instability.

### SUMMARY

In described examples, a device includes first and second inductors, first and second phase switching circuits, a proportional-integral (PI) compensator, and a controller. The first and second phase switching circuits are respectively coupled to the first and second inductors. The controller is coupled to the first and second phase switching circuits and the PI compensator. The controller performs the following actions. It generates a phase error signal responsive to a phase difference between first and second control signals respectively corresponding to the first and second phase switching circuits, a switching period, and a target phase delay between the first and second control signals. It provides the phase error signal to the PI compensator. And it controls the first and second phase switching circuits in a first phase and a second phase, respectively, responsive to the first and second control signals and a PI compensator output signal.

In described examples, a device includes first and second inductors, first and second phase switching circuits, and a controller. A first terminal of the first phase switching circuit is coupled to a first terminal of the first inductor. A first terminal of the second phase switching circuit is coupled to a first terminal of the second inductor. The controller includes a proportional-integral (PI) compensator. First and second outputs of the controller are respectively coupled to control terminals of the first and second phase switching circuit. The third output of the controller is coupled to the first input of the PI compensator. The controller performs the following actions. It generates a phase error signal responsive to a switching period, a target phase delay of the second control signal with respect to the first control signal, and a phase difference between a first control signal corresponding to the first phase switching circuit and a second control signal corresponding to the second phase switching circuit. It provides the phase error signal to the first input of the PI compensator. And it controls the first phase switching circuit in a first phase and the second phase switching circuit in a second phase, responsive to the first and second control signals and an output signal of the PI compensator.

In described examples, a device includes a sensor, a first phase switching circuit, a second phase switching circuit, a gate driver, and a controller. The first and second outputs of the gate driver are coupled to the control terminals of the first and second phase switching circuits, respectively. The controller includes a PI compensator. An input of the controller is coupled to an output of the sensor. A first output of the controller is coupled to the input of the gate driver. A second output of the controller is coupled to a first input of the PI compensator. The controller performs the following actions. It generates a phase error signal responsive to a phase difference between a switching period, a target phase delay of the second control signal with respect to the first control signal, and a first control signal corresponding to the first phase switching circuit and a second control signal corresponding to the second phase switching circuit. It provides the phase error signal to the first input of the PI compensator. And it controls the first phase switching circuit in a first phase and the second phase switching circuit in a second phase, responsive to the first and second control signals and an output signal of the PI compensator.

### BRIEF DESCRIPTION OF THE DRAWINGS

FIG. 1A is a functional block and circuit diagram of an example power converter system.

FIG. 1B is a functional block and circuit diagram of a second example power converter system.

FIG. 1C is a functional block and circuit diagram of a third example power converter system.

FIG. 2A is a first set of graphs of example signals corresponding to PWM control of the first phase circuit of the power converter system of FIG. 1A.

FIG. 2B is a second set of graphs of example signals corresponding to PWM control of the first phase circuit of the power converter system of FIG. 1A.

FIG. 3A is a state-plane diagram of example signals of the power converter system of FIG. 1A, responsive to PWM control as described with respect to FIGS. 2A and 2B.

FIG. 3B is a set of tables showing equations described with respect to FIG. 3A, enabling example control of the boost converter system 100 of FIG. 1A.

FIG. 4 is a functional block diagram of an example of the phase timing adjustment (PTA) module of FIG. 1A.

FIG. 5 is a process flow diagram of an example process for generating a phase delay timing adjustment value using the PTA module of FIGS. 1 and 4.

FIG. 6 is a graph of example inductor current against time for the power converter system of FIG. 1A, responsive to phase timing adjustment as described with respect to FIGS. 4 and 5.

FIG. 7 is a graph of example signals of the power converter system of FIG. 1A, responsive to delay between input voltage measurement by the signal sensor and processing of the input voltage measurement.

FIG. 8 is a functional block diagram of a compensation module for correcting a measured input voltage for measurement and/or signal path delay.

FIG. 9 is a process flow diagram of an example process for correcting a measured input voltage value responsive to measurement and signal path delay, as described with respect to FIG. 8.

FIG. 10 is a graph of total harmonic distortion in an output signal against load in the power converter system of FIG. 1A.

### DETAILED DESCRIPTION

Multiphase boost converters are useful in a variety of applications, such as industrial and automotive applications. Multiphase boost converters include a first phase circuit connected to and that transfers power across a first inductor, and a second phase circuit connected to and that transfers power across a second inductor. Switches of the first phase circuit control application of energy to the first inductor to store or discharge magnetic energy. Similarly, switches of the second phase circuit control application of energy to the second inductor to store or discharge magnetic energy.

The second phase switches are controlled to open and close with a phase delay with respect to control of the first phase switches. This phase delay can be provided using a delay circuit that provides second phase control signals with a delay time responsive to a set of input, feedback, and control information, along with certain physical properties of the power converter. For example, for two phase circuits, a phase delay of 180 degrees (π radians) is used, and for a number P^{th} phase circuit out of a number N phase circuits in a power converter, a phase delay of (P−1)*(360 degrees)/N or (P−1)*(2π radians)/N is used. In some examples, various counters are used to determine switch turn-on (activation) and turn-off (deactivation) timing, and to determine phase delay duration. In an example, a phase delay counter is reset responsive to a first phase circuit switch turn-off event, such as a falling edge of a corresponding PWM control signal, and triggers a second phase circuit switch turn-on responsive to the counter exceeding a threshold corresponding to a determined phase delay. In some examples, other counter reset triggers, or other types of comparison to determine phase delay end, are used.

Some ZVS-QSW power converters are used in power factor correction (PFC) applications. In some examples, power drawn from an alternating current (AC) power supply line in which current and voltage are not in phase causes or is correlated with generation of harmonics in the power signal. In an AC power signal, out-of-phase current and voltage, and/or harmonics, may result in wasted power. In an example, a PFC power converter shapes power drawn from an AC power supply line so that a current draw waveform is a sinusoidal wave that has a same shape as and is in phase with a corresponding voltage waveform so that harmonics are reduced, enabling reduced power loss.

In some examples, a ZVS-QSW PFC power converter uses triangular current mode (TCM) control with multiple, interleaved phases with precisely timed switch control to reduce input ripple current and improve system efficiency. Zero current detection (ZCD) control can be used to improve cycle-by-cycle control of a synchronous rectifier in a ZVS-QSW power converter. In an example, ZCD control corresponds to switch turn-off timing responsive to detecting zero current through the switch. In some examples, an effective switching period of a power converter system using ZCD control changes from cycle to cycle, responsive to variations in signal levels corresponding to voltage and temperature fluctuations. In such examples, counter values or thresholds may not track a designed target phase delay quickly enough or accurately enough to meet design requirements.

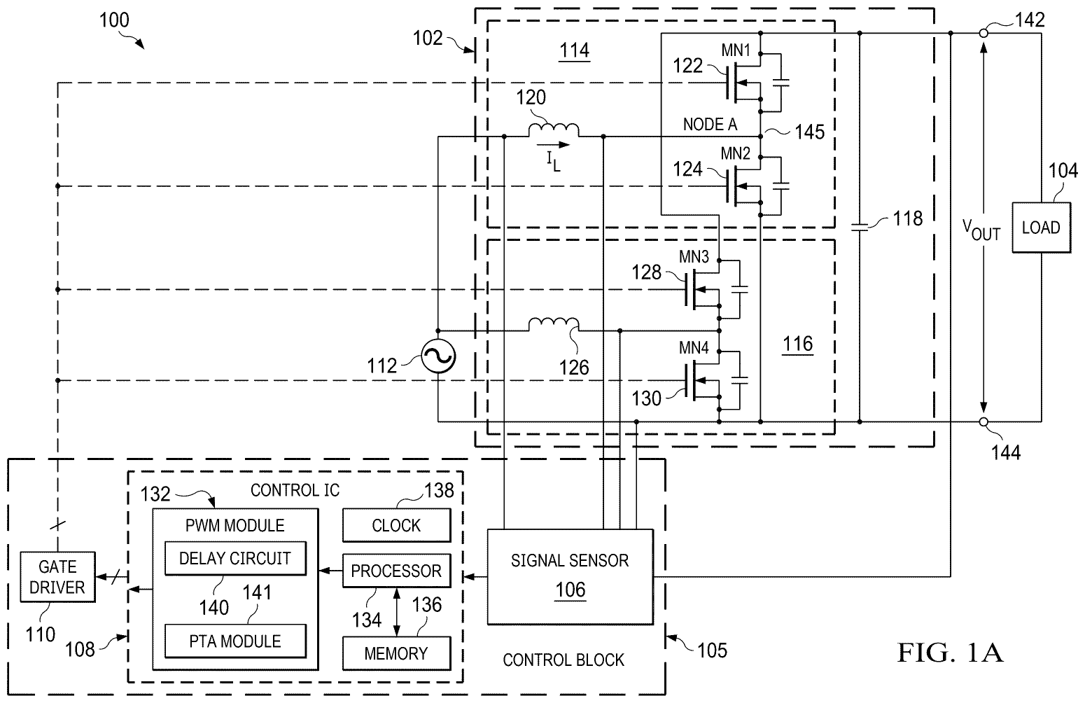

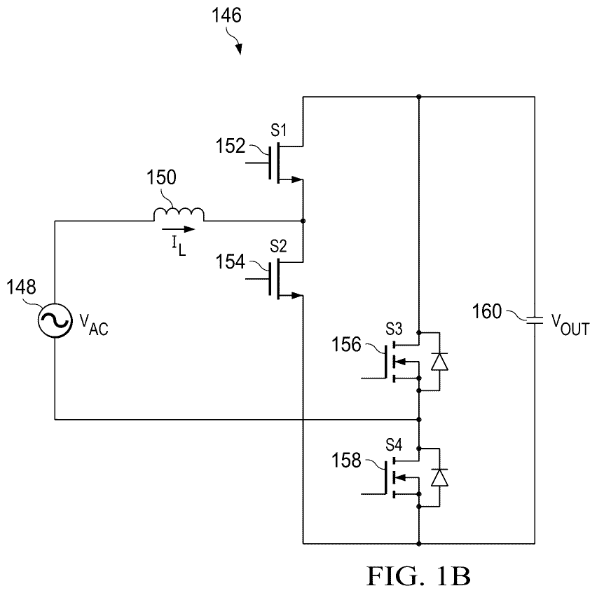

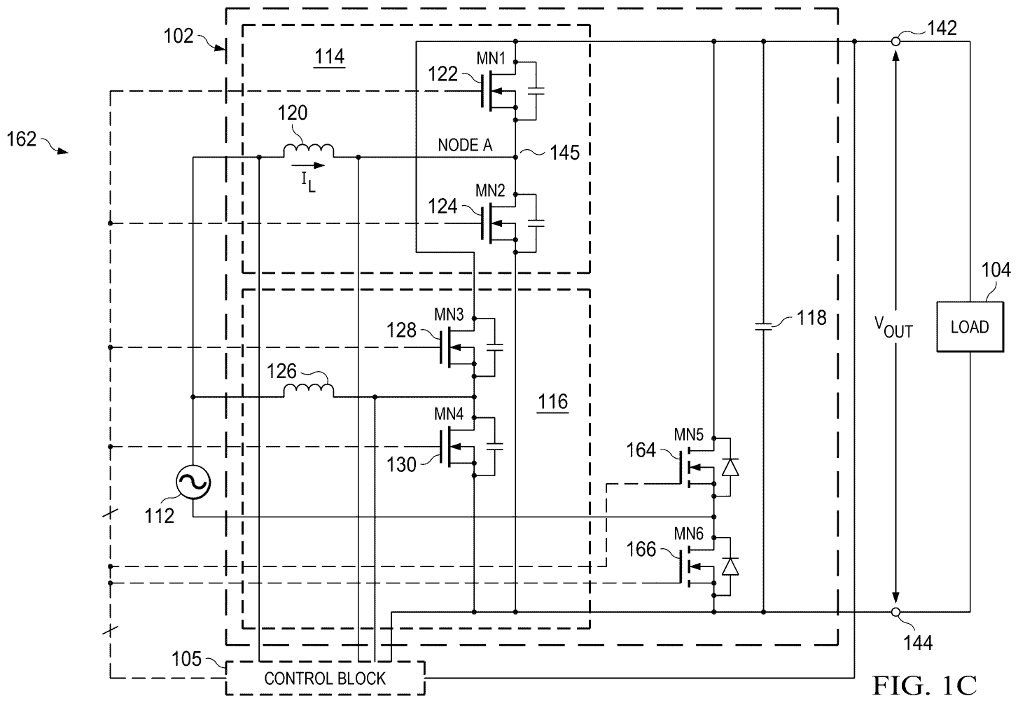

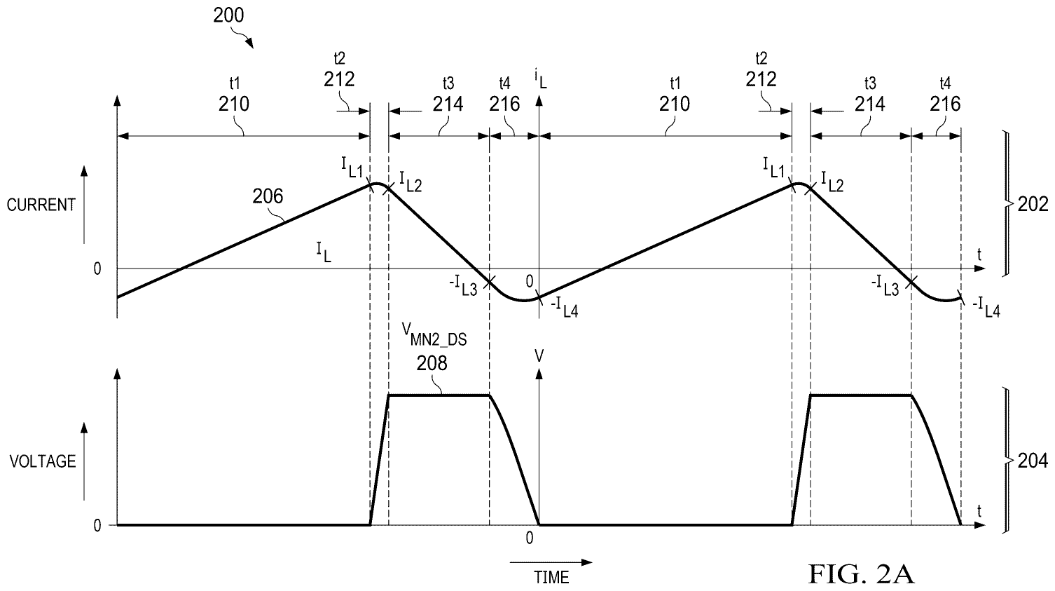

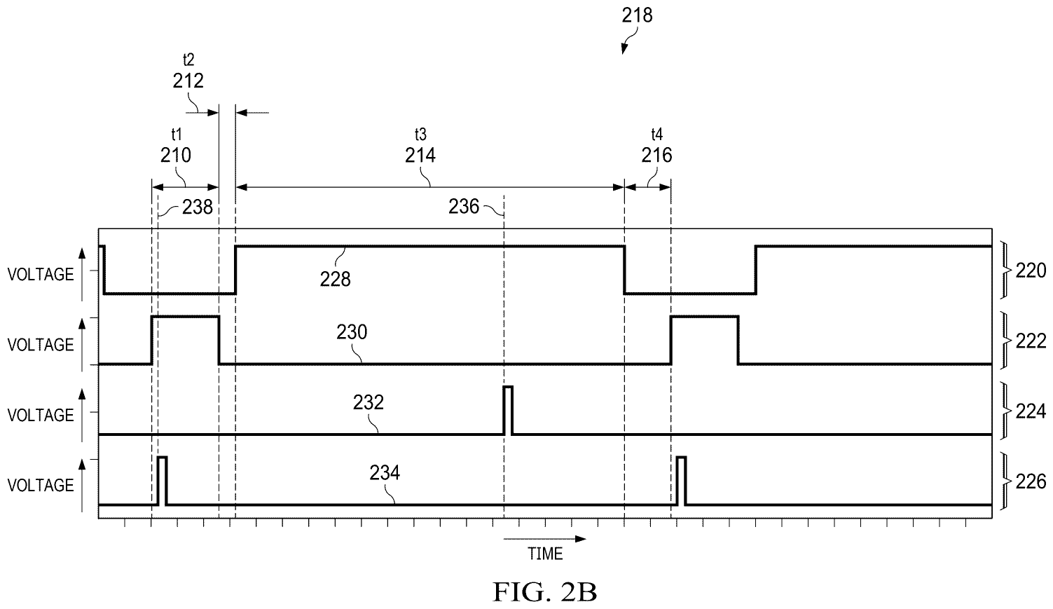

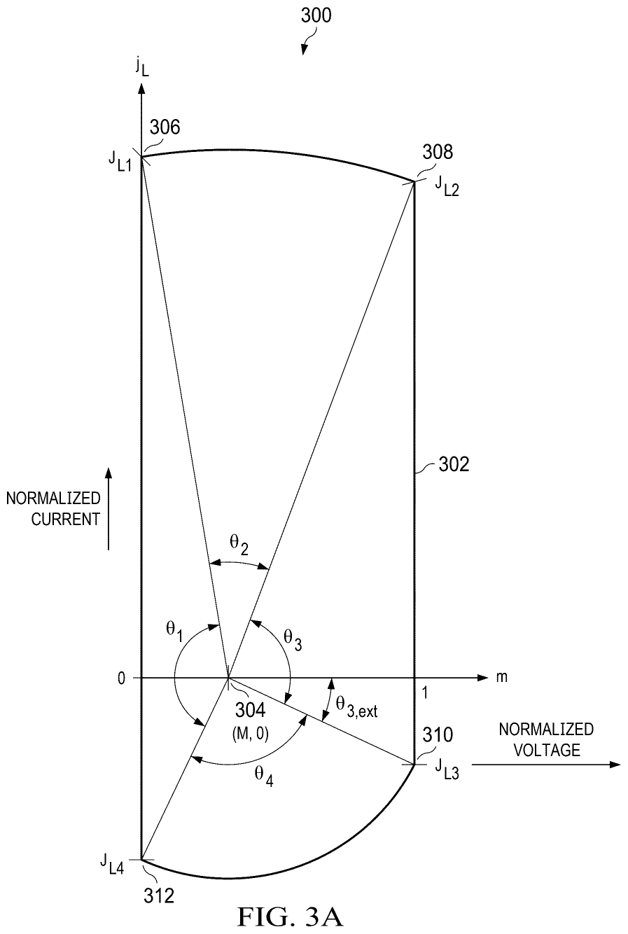

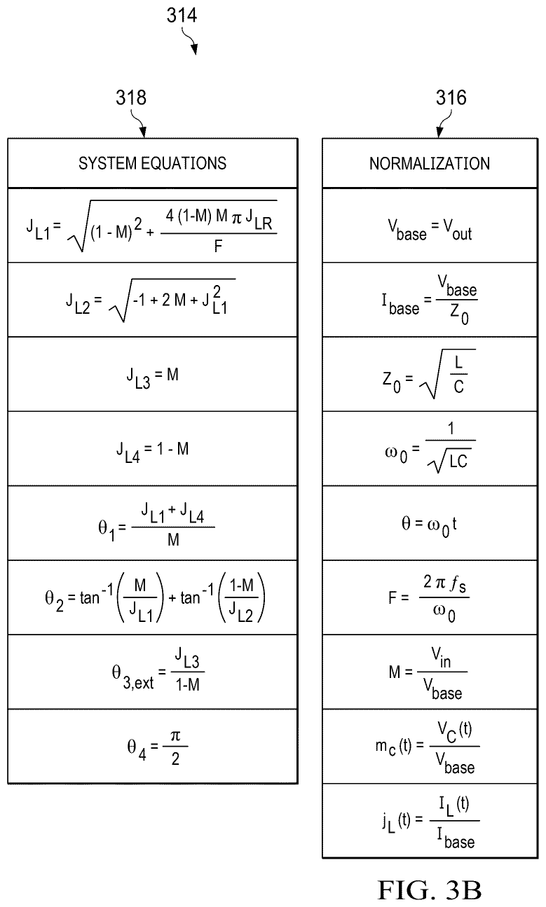

An example ZVS-QSW boost converter system 100 is further described below with respect to FIG. 1A. Precise, deterministic control of the boost converter system 100 of FIG. 1A is further described with respect to FIGS. 2A, 2B, 3A and 3B. Described systems and processes enable more precise determination of switch timing and other control parameters to improve stability and efficiency of an interleaved, multiphase ZVS-QSW power converter.

Two example approaches to improving switch control of an interleaved, multiphase ZVS-QSW power converter are described herein. The first approach relates to deviations of phase delay and/or current balance between different phases of a multiphase converter from designed values. In some examples, such deviations are caused by event detection delay or by process variation. Phase delay deviation can be measured after manufacturing, such as during device test, to determine proportional and integral compensation factors. These compensation factors can be provided to a proportional-integral (PI) compensator, along with measured phase delay error, to generate an adjustment factor. This adjustment factor can be applied in various ways to improve power converter performance, for example, to reduce phase delay error and improve current balance.

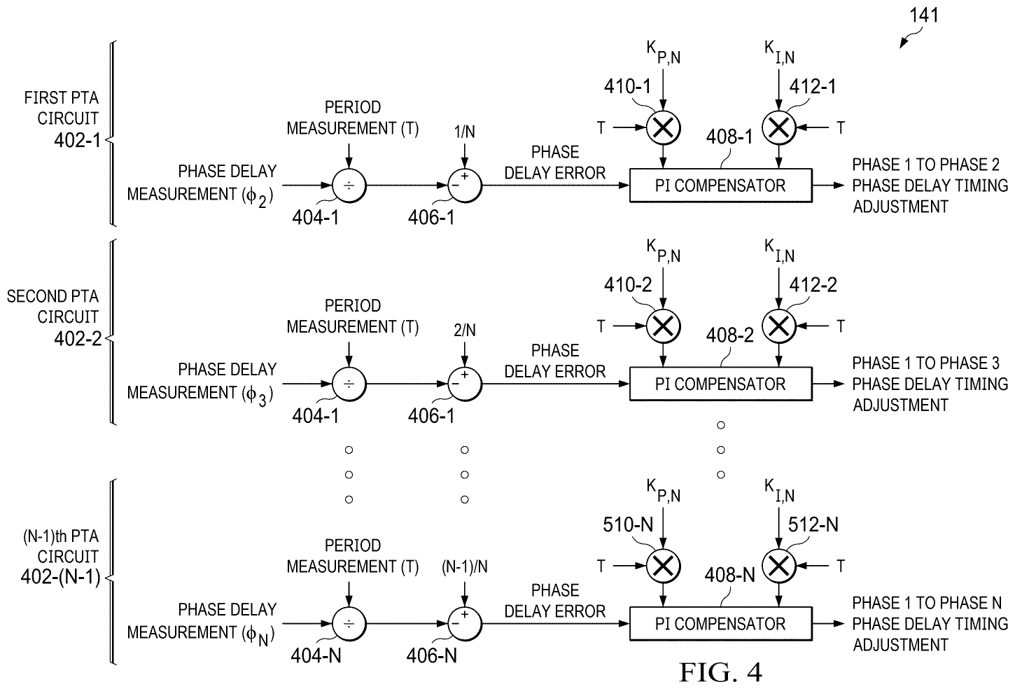

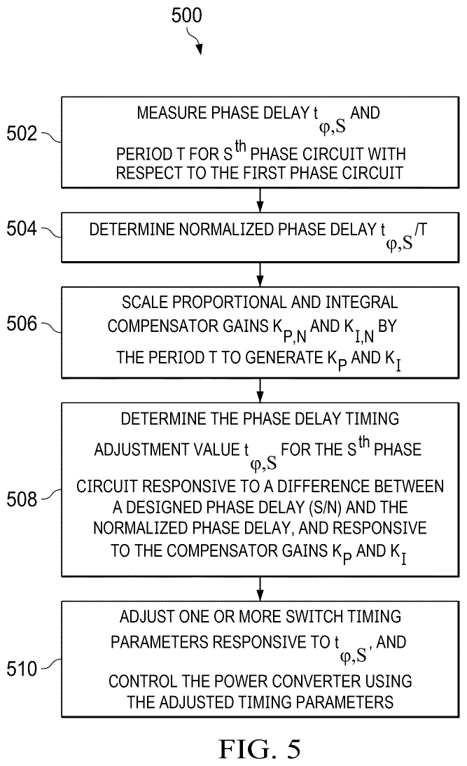

Compensating for detection delay and signal propagation delay responsive to ZCD through a control switch and/or a rectifier switch is further described below with respect to FIGS. 4 and 5. This corresponds to the first approach for improving power converter performance described above. In some examples, such compensation enables improved switch on-off timing determination. Improved (such as more precise) determination of switch on-off timing in interleaved, multiphase converters enables some or all of various benefits, such as higher efficiency, reduced harmonics, improved signal shaping, improved system stability, improved current balance between phases, and improved compliance of phase delay to system design.

The second approach relates to lag between measurement of input voltage and receipt by a switch of a responsive control signal. This lag can cause delivered power signals to deviate from design. Measured AC input voltage, which is used to determine switch timing, is not the same at the time of measurement as at the time of switch control signal receipt. A compensation factor can be determined post-manufacturing and used to correct for the measurement-to-control lag.

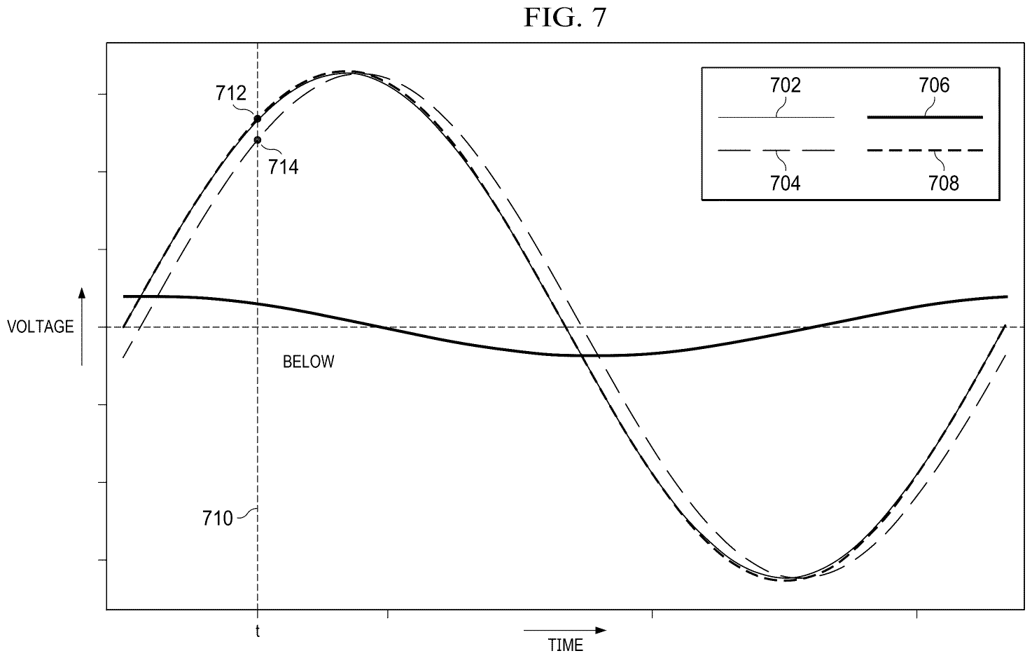

Compensating for measurement and signal propagation delay responsive to an input voltage level is further described below with respect to FIGS. 7, 8, and 9. This corresponds to the second approach for improving power converter performance described above. Improved (such as more precise) determination of phase delay in interleaved, multiphase converters enables some or all of various benefits, such as higher efficiency, reduced harmonics, improved signal shaping, improved system stability, improved current balance between phases, and improved compliance of phase delay to system design.

Herein, some structures or signals that are distinct but related have reference numbers that use a [number][dash][number] format, such as a first PTA circuit 402-1 and a second PTA circuit 402-2. In some examples, these structures or signals are referred to generally, in the singular or as a group, using the [number] and without the [dash][letter], such as PTA circuits 402.

For convention in this document, metal-oxide-semiconductor field-effect transistors (MOSFETS) are numbered as M [channel type][number], where the number increases for each differing transistor of a same channel type. Channel types include n-channel MOSFETS (NMOS) and p-channel MOSFETS (PMOS). The channel type for each transistor is only an example, and other examples may substitute another transistor of a different type for any illustrated transistor. Also, the same reference numbers or other reference designators are used in the drawings to designate features that are related structurally and/or functionally.

FIG. 1A is a functional block and circuit diagram of an example boost converter system 100. In an example, the boost converter system 100 receives alternating current (AC) power, and outputs direct current (DC) power. Accordingly, the boost converter system 100 is an AC-DC converter. The boost converter system 100 includes a two phase boost converter 102, a load 104, a control block 105 that includes a signal sensor 106, a control integrated circuit (IC) 108, and a gate driver circuit 110, and an AC voltage source 112. In some examples, systems and processes described herein are applicable to multiphase ZVS-QSW power converters other than boost converters, such as a buck, buck-boost, or flyback converter.

The boost converter system 100 illustrated in FIG. 1A corresponds to one half of a period of a voltage signal provided by the AC voltage source 112. A boost converter 146 corresponding to the entire period voltage signal provided by the AC voltage source 112 is described with respect to FIG. 1B. A two phase boost converter system 162 corresponding to the entire period voltage signal provided by the AC voltage source 112 is described with respect to FIG. 1C.

The two phase boost converter 102 includes a first phase circuit 114, a second phase circuit 116, and a capacitor 118. The first phase circuit 114 includes a first energy storage device (e.g., first inductor 120), a first NMOS (MN1) 122, and a second NMOS (MN2) 124. The second phase circuit 116 includes a second energy storage device (e.g., second inductor 126), a third NMOS (MN3) 128, and a fourth NMOS (MN4) 130. MN1 122, MN2 124, MN3 128, and MN4 130 are collectively referred to as the switches.

The control IC 108 includes a PWM module 132, a processor 134, a memory 136, and a clock circuit 138. The PWM module 132 includes a delay circuit 140 and a phase timing adjustment (PTA) module 141. In some examples, the PWM module 132 controls the switches 122, 124, 128, and 130 via the gate driver 110 responsive to hardware, software, or a combination thereof. In some examples, the processor 134 is a central processing unit (CPU), a digital signal processor (DSP), or a microcontroller unit (MCU). In some examples, the processor 134 provides signals to the PWM module 132, such as control signals or sampled sensor information, responsive to hardware, software, or a combination thereof.

The memory 136 includes a memory circuit storing instructions for performing an interrupt service routine (ISR) or other background process (or other process) for controlling the PWM module 132. In some examples, a PWM control process is stored in a flash memory bank of the memory 136. In some examples, signals responsive to voltage and/or current measurements by the signal sensor 106 are sampled by circuits of the control IC 108, such as the circuits of the processor 134. Sample values are processed by the processor 134 and/or stored by the memory 136.

In some examples, an ISR refresh rate (execution frequency) is between 50 and 100 kilohertz. Accordingly, a switching frequency of MN1 122, MN2 124, MN3 128, and MN4 130 may be between 70 kilohertz and 1.2 megahertz. A typical line frequency of an input voltage signal corresponding to a power signal provided by a power line corresponding to the voltage source 112 is 50 to 60 Hertz. Accordingly, the ISR refresh rate is similar to or slower than the switching frequency, and faster than the line frequency.

A first terminal of the voltage source 112 is connected to a first terminal of the first inductor 120, a first terminal of the second inductor 126, and a first input of the signal sensor 106. A second terminal of the first inductor 120 is connected to a source of MN1 122, a drain of MN2 124, and a second input of the signal sensor 106. A node A 145 is located between the source of MN1 122 and the drain of MN2 124. A second terminal of the second inductor 126 is connected to a source of MN3 128, a drain of MN4 130, and a third input of the signal sensor 106. Gates of MN1 122, MN2 124, MN3 128, and MN4 130 are connected to output(s) of the gate driver circuit 110. In some examples, gates of MN1 122 and MN2 124 are connected to a first set of complementary outputs of the gate driver circuit 110, and gates of MN3 128 and MN4 130 are connected to a second set of complementary outputs of the gate driver circuit 110.

Drains of MN1 122 and MN3 128 are connected to a first terminal of the capacitor 118, a first output terminal 142, and a fourth input of the signal sensor 106. A second terminal of the voltage source 112 is connected to sources of MN2 124 and MN4 130, a second terminal of the capacitor 118, a second output terminal 144, and a fifth input of the signal sensor 106. The first output terminal 142 is connected to a first terminal of the load 104. The second output terminal 144 is connected to a second terminal of the load 104. In an example, first, second, third, fourth, and fifth inputs of the signal sensor 106 correspond to first, second, third, fourth, and fifth inputs of the control block 105, respectively.

MN1 122, MN2 124, MN3 128, and MN4 130 serve a switching function for the boost converter 102. MN1 122 and MN2 124 control current flow through the first inductor 120, and MN3 128 and MN4 130 control current flow through the second inductor 126. Accordingly, MN1 122, MN2 124, MN3 128, and MN4 130 control transfer of energy from the voltage source 112 to the load 104. A voltage between the first output terminal 142 and the second output terminal 144 corresponds to an output voltage V_{OUT} of the boost converter 102, accordingly, a voltage across the load 104.

An output of the signal sensor 106 is connected to an input of the control IC 108. The processor 134 is bidirectionally connected to communicate with the memory 136. An output of the processor 134 is connected to an input of the PWM module 132. Output of the control IC 108 is connected to input of the gate driver circuit 110. In some examples, multiple outputs of the control IC 108, corresponding to the multiple phase circuits of the boost converter 102, are connected to corresponding inputs of the gate driver circuit 110.

The processor 134 controls the PWM module 132 responsive to instructions in the memory 136 (such as the ISR described above) and responsive to feedback signals provided by the signal sensor 106. The PWM module 132 controls the gate driver 110. The gate driver 110 controls MN1 122, MN2 124, MN3 128, and MN4 130 to turn on and turn off. MN1 122 and MN2 124 are controlled to enable energy transfer across the first inductor 120. MN3 128 and MN4 130 are controlled to enable energy transfer across the second inductor 126.

In some examples, the signal sensor 106 provides to the control IC 108 signals indicating voltage and/or current of signals of the boost converter 102, and the control IC 108 samples the signals to determine voltage and/or current values and/or related information. In some examples, the signal sensor 106 senses and/or samples the boost converter 102 signals to determine voltage and/or current values and/or related information. In some examples, determined voltage and/or current values and/or related information includes a maximum voltage of an AC signal (such as a line signal corresponding to an input voltage provided by the voltage source 112), an output voltage, current I_{L} through the first inductor 120, a detection of zero current (ZCD) through MN1 122 (e.g., a high side switch) indicator, or a ZCD through MN2 124 (e.g., a low side switch) indicator.

FIG. 1B is a functional block and circuit diagram of a second example power converter system 146. In an example, the power converter system 146 of FIG. 1B corresponds to one phase (e.g., the first phase circuit 114 or the second phase circuit 116) of the boost converter 102 of FIG. 1A. The power converter system 146 includes an AC voltage source 148, an inductor 150, a first NMOS (S1) 152, a second NMOS (S2) 154, a third NMOS (S3) 156, a fourth NMOS (S4) 158, and an output capacitor 160. In an example, S1 152 and S2 154 correspond to MN1 122 and MN2 124, respectively. In an example, S3 154 and S4 156 are enhancement mode FETs.

A first terminal of the AC voltage source 148 is connected to a first terminal of the inductor 150. A second terminal of the inductor 150 is connected to sources of S1 152 and S3 156 and drains of S2 154 and S4. Drains of S1 152 and S3 156 are connected to a first terminal of the output capacitor 160, and sources of S2 154 and S4 158 are connected to a second terminal of the output capacitor 160.

Returning to FIG. 1A, the operation of each phase circuit of the boost converter 102 is generally controlled by the closed or open state of a respective control switch and what will be referred to as a rectifier switch, as now described. In some examples in which the voltage source 112 provides an AC signal, as in the power converter system 146 of FIG. 1B, MN1 122 and MN3 128 function as rectifier switches for one half (a positive voltage half or a negative voltage half) of the period of the AC signal, and as control switches for one half (a negative voltage half or a positive voltage half) of the period of the AC signal. Similarly, MN2 124 and MN4 130 function as control switches for one half (a positive voltage half or a negative voltage half) of the period of the AC signal, and as rectifier switches for one half (a negative voltage half or a positive voltage half) of the period of the AC signal. Herein, for convenience, one half of the period of the AC signal is described: MN1 122 and MN3 128 are described as rectifier switches, and MN2 124 and MN4 130 are described as control switches. Functionality described herein also applies to the other half of the AC signal period.

During a dead time (also referred to as a dead band), both the control switch and the rectifier switch are open to prevent shoot-through. Other than during dead times, within a phase circuit 114 or 116, one of the control switch and the rectifier switch is closed and the other is open. A dead time interposes between the control switch and the rectifier switch changing which is open and which is closed.

“Phase,” without the word “circuit,” is used herein to refer to a control duration of a switching period of a phase circuit 114 or 116. Accordingly, each phase circuit 114 or 116 is controlled to have two phases and two dead times within a switching period. In a first phase, also referred to herein as an energy storing phase, MN1 122 or MN3 128 is open, and MN2 124 or MN4 130 is closed (respectively). During the energy storing phase, current across the inductor 120 or 126 is increased. Moreover, the inductor 120 or 126 stores energy by generating a magnetic field while current flows from the voltage source 112 through the inductor 120 or 126 and MN2 124 or MN4 130. Also, the capacitor 118 discharges across the load 104. A body diode of MN1 122 or MN3 128 prevents the capacitor 118 from discharging across MN1 122 or MN3 128 (respectively).

In a second phase, also referred to herein as a discharge phase, MN1 122 or MN3 128 is closed, and MN2 124 or MN4 130 is open (respectively). Energy stored in the inductor 120 or 126 is discharged as current through the load 104, and charges the capacitor 118.

The clock circuit 138 generates a clock signal. The control IC 108 receives from the signal sensor 106 voltage and/or current information, which is sampled and processed by the processor 134. The PWM module 132 generates a PWM control signal for the first phase circuit 114 responsive to the clock signal and the processed signal information. The delay circuit 140 generates a PWM control signal for the second phase circuit 116 responsive to the first phase circuit PWM control signal, with a phase delay that shifts the second phase circuit PWM control signal later in time. In some examples, the second phase circuit PWM control signal for the second phase circuit 116 is the same as the first phase circuit PWM control signal but with the added phase delay.

In some examples, the delay provided by the delay circuit 140 is determined so that the second phase PWM control signal has a phase delay with respect to the first phase PWM control signal that equals 180° (π radians). In some examples, a designed phase delay responsive to circuit conditions is other than 180° (π radians). In some examples, a designed phase delay for a P^{th} phase (integer P) of an integer N number of phases is or is responsive to (P−1)*(360 degrees)/N or (P−1)*(2π radians)/N.

In some examples, various factors can introduce an error in a determined phase delay time or in a second phase current. In some examples, delay error or current imbalance can arise due to delay between a signal event such as zero current through a switch 122, 124, 128, or 130 and generation of a signal responsive to measurement of that signal event. Delay error or current imbalance may also be caused by variations in device parameters introduced during manufacturing (for example, process variation). The delay circuit 140 adjusts the phase delay for the second phase circuit PWM control signal responsive to the PTA module 141 to correct phase delay and/or current imbalance errors. Function of the PTA module 141 is further described with respect to FIGS. 4 and 5.

FIG. 1C is a functional block and circuit diagram of a third example boost converter system 162. In addition to the structures of the boost converter system 100 of FIG. 1A, the boost converter system 162 of FIG. 1C includes a fifth n-channel MOSFET (MN5) 164 and a sixth n-channel MOSFET (MN6) 166. In an example, MN5 164 and MN6 166 are enhancement mode FETs.

The second terminal of the voltage source 112 is connected to a source of MN5 164, a drain of MN6 166, and a sixth input of the control block 105 (corresponding to a sixth input of the signal sensor 106). Drains of MN1 122, MN3 128, and MN5 164 are connected to the first terminal of the capacitor 118, the fourth input of the control block 105, and the first output terminal 142. Sources of MN2 124, MN4 130, and MN6 166 are connected to the fifth input of the control block 105, the second terminal of the capacitor 118, and the second output terminal 144. The output of the control block 105 is connected to the gates of MN1 122, MN2 124, MN3 128, MN4 130, MN5 164, and MN6 166.

In a first half of a period of the voltage signal provided by the voltage source 112, MN6 166 is closed and MN5 164 is open. This corresponds to connectivity described with respect to the boost converter 102 of FIG. 1A. Accordingly, operation of the boost converter system 162 under this condition corresponds to operation of the boost converter system 100 as described with respect to FIG. 1A.

In a second half of a period of the voltage signal provided by the voltage source 112, MN5 164 is closed and MN6 166 is open. Operation of the two phase boost converter system 162 under this condition is similar to operation of the two phase boost converter system 100, except that MN1 122 and MN3 128 function as control switches, and MN2 124 and MN4 130 function as rectifier switches. Accordingly, control and response signal behavior with respect to MN1 122 is swapped with control and response signal behavior with respect to MN2 124. Similarly, control and response signal behavior with respect to MN3 128 is swapped with control and response signal behavior with respect to MN4 130.

FIG. 2A is a first set of graphs 200 of example signals corresponding to PWM control of the first phase circuit 114 of the power converter system of FIG. 1A, via signals of the gate driver 110 as further described in FIG. 2B. The graphs 200 include a first graph 202 and a second graph 204. A horizontal axis of each of the graphs 202 and 204 indicates time. A vertical axis of the first graph 202 indicates current. A vertical axis of the second graph 204 indicates voltage. The first graph 202 includes an inductor current (I_{L}) curve 206, which represents current through the first inductor 120. The second graph 204 includes an MN2 voltage curve (V_{MN2_DS}) 208, which indicates a drain-source voltage (V_{DS}) of MN2 124.

A switching period of the first phase circuit 114 includes four durations, namely, t1 210, t2 212, t3 214, and t4 216, each corresponding to a switching state of MN1 122 and MN2 124. At the beginning of t1 210, there is zero voltage across MN2 124, enabling MN2 124 to turn on with reduced (or minimal) loss, corresponding to ZVS. Accordingly, MN1 122 remains off and MN2 124 turns on. MN2 124 turning on (closing) provides a low resistance conductive path across which the voltage is very low or zero, so I_{L} 206 increases linearly. Accordingly, t1 210 corresponds to the energy storing phase of the first phase circuit 114.

At the beginning of t2 212, MN1 122 remains off and MN2 124 turns off, so that t2 212 corresponds to a first dead time. During t2 212, I_{L} 206 increases slightly, and then begins to decrease as I_{L} 206 discharges the parasitic capacitance of MN1 122 and charges the parasitic capacitance of MN2 124. Charging the parasitic capacitance of MN2 124 causes the MN2 voltage curve 208 to increase from zero to the line voltage provided by the voltage source 112.

At the beginning of t3 214, there is zero voltage across MN1 122, enabling MN1 122 to turn on with reduced (or minimal) loss, corresponding to ZVS. Accordingly, MN1 122 turns on and MN2 124 remains off. Initially, conduction by MN1 122 may correspond to a third quadrant conduction feature of MN1 122 or activation of a body diode of MN1 122. During t3 214, current through the first inductor 120 is provided to the load 104 and charges the capacitor 118, so that current through the first inductor 120 decreases. Accordingly, t3 214 corresponds to the discharge phase of the first phase circuit 114.

At the beginning of t4 216, MN1 122 turns off and MN2 124 remains off, so that t4 216 corresponds to a second dead time. During t4 216, I_{L} 206 decreases slightly, and then begins to increase as I_{L} 206 charges the parasitic capacitance of MN1 122 and discharges the parasitic capacitance of MN2 124. Discharging the parasitic capacitance of MN2 124 causes the MN2 voltage curve 208 to decrease from V_{DC} to zero.

FIG. 2B is a second of graphs 218 of example signals corresponding to PWM control of the first phase circuit 114 of the power converter system of FIG. 1A. The graphs 218 include a first graph 220, a second graph 222, a third graph 224, and a fourth graph 226. A horizontal axis of each of the graphs 220, 222, 224, and 226 indicates time. A vertical axis of each of the graphs 220, 222, 224, and 226 indicates voltage.

The first graph 220 includes an MN1 122 (or high side switch) PWM control signal 228. The second graph 222 includes an MN2 124 (or low side switch) PWM control signal 230. The third graph 224 includes a high side ZCD signal 232, which indicates a time when a current through the high side switch (such as MN1 122) equals zero. The fourth graph 226 includes a low side ZCD signal 234, which indicates a time when a current through the low side switch (such as MN2 124) equals zero. In some examples, the high side and low side ZCD signals 232 and 234 are provided by the signal sensor 106, or by signal sensor structure within MN1 122, MN2 124, MN3 128, and/or MN4 130.

In the high side and low side PWM control signals 228 and 230, a high voltage corresponds to controlling the respective switch to turn on. A low voltage corresponds to turning the respective switch to turn off. In the high side and low side ZCD signals 232 and 234, a low voltage indicates no ZCD event is detected through MN1 122 or MN2 124 (respectively), and a high voltage indicates a ZCD event is detected through MN1 122 or MN2 124 (respectively).

There is a high side ZCD event at a first time 236, and a low side ZCD event at a second time 238. In some examples, a turn-off time for MN1 122 is responsive to the first time 236, and a turn-off time for MN2 124 is responsive to the second time 238. In some examples, the turn-off time for MN1 122 is responsive to the first time 236 while MN1 122 is the rectifier switch (such as while MN5 164 is closed and MN6 166 is open), and not while MN1 122 is the control switch (such as while MN5 164 is open and MN6 166 is closed). In some examples, the turn-off time of MN2 124 is responsive to the second time 238 while MN2 124 is the rectifier switch (such as while MN5 164 is open and MN6 166 is closed) and not while MN2 124 is the control switch (such as while MN5 164 is closed and MN6 166 is open).

Note that ZCD detection is not instantaneous, and a signal path from a ZCD event to responsive switch (such as MN1 122 or MN2 124) control is also not instantaneous. Control responsive to a ZCD event, including correction for ZCD detection and other related delay along a signal path to responsive switch control, is further described with respect to FIGS. 3A, 3B, 4, and 5.

FIG. 3A is a state-plane diagram 300 of example signals of the boost converter system 100 of FIG. 1A, responsive to PWM control as described with respect to FIGS. 2A and 2B. The state-plane diagram 300 maps the time domain waveforms I_{L}(t) 206 and v(t) 208 (FIG. 2A) to a normalized voltage domain current signal 302.

A vertical axis indicates normalized current J_{L} (or J_{L}(t)), which is described by Equation 9, below. A horizontal axis indicates normalized voltage m (or m_{C}(t)), which is described by Equation 8. A center point of the state-plane diagram 300 is located at (M, 0), where M is a normalized value of the instantaneous (for example, measured) input voltage V_{IN} provided by the voltage source 112. M is further described with respect to Equation 7, below.

The normalized voltage domain current signal 302 has four corners as shown in FIG. 3A. A normalized current at a first corner 306 is J_{L1}, a normalized current at a second corner 308 is J_{L2}, a normalized current at a third corner 310 is J_{L3}, and a normalized current at a fourth corner 312 is J_{L4}. J_{L1}, J_{L2}, J_{L3}, and J_{L4} are normalized currents at the beginnings of durations t1 210, t2 212, t3 214, and t4 216, respectively. J_{L1} and J_{L4} correspond to a zero normalized voltage, and accordingly are a magnitude M to the left of the center point of the state-plane diagram 300. J_{L2} and J_{L3} correspond to a one normalized voltage, and accordingly are a magnitude one minus M to the right of the center point of the state-plane diagram 300.

C is the sum of the capacitances at node A 145, accordingly, the source-drain capacitances of M1 122 and M2 124 and the corresponding conductive line(s). θ₁, θ₂, θ₃, and θ₄ are normalized angles that sum up to one switching period of the first phase circuit 114. Normalized angles θ₁, θ₂, θ₃, and θ₄ are swept by the voltage domain current signal J_{L}(v) in durations t1 210, t2 212, t3 214, and t4 216, respectively.

Some or all of the values described above (and/or other values, such as other properties of the boost converter 102 or of its operation) can be derived precisely and in real time to provide some or all of various benefits, including: higher efficiency, reduced harmonics, improved signal shaping, improved system stability, improved current balance between phases, and improved compliance of phase delay to system design. This derivation, and use of these values to control the boost converter 102, are further described below.

Herein, L is the inductance of the first inductor 120. R₀, a characteristic impedance of the first phase circuit 114, is shown in Equation 1. The resonant frequency ω₀ of the boost converter 102 is shown in Equation 2.

$${R}_{0} = \sqrt{L / C} \qquad Equation 1$$

$${ω}_{0} = \frac{1}{\sqrt{LC}} \qquad Equation 2$$

Equations 3 and 4 describe a normalizing factor for voltage V_{base} and a normalizing factor for current I_{base}, respectively. V_{base} corresponds to output voltage, and I_{base} corresponds to output current.

$${V}_{base} = {V}_{OUT} \qquad Equation 3$$

$${I}_{base} = \frac{{V}_{OUT}}{{R}_{0}} \qquad Equation 4$$

An angle θ (theta) in the state-plane diagram 300 is given in Equation 5 (θ can exceed 2π radians). A normalized frequency F is shown in Equation 6, where f_{SW} is the switching frequency of the boost converter 102.

$$θ = {ω}_{0} t \qquad Equation 5$$

$$F = \frac{2 π {f}_{SW}}{{ω}_{0}} \qquad Equation 6$$

A normalized input voltage M is shown in Equation 7, in which V_{IN} is the input voltage at a time. A normalized voltage at node A 145 (e.g., across MN2 124) m_{C}(t) is shown in Equation 8.

$$M = \frac{{V}_{IN}}{{V}_{base}} \qquad Equation 7$$

$${m}_{C} ( t ) = \frac{{V}_{C} ( t )}{{V}_{base}} \qquad Equation 8$$

The current I_{L}(t) through the first inductor 120 at time t is shown in Equation 9.

$${J}_{L} ( t ) = \frac{{I}_{L} ( t )}{{I}_{base}} \qquad Equation 9$$

During a switching period of the first phase circuit 114, the state-plane diagram 300 sweeps through a normalized angle corresponding to a full circle, which is described by Equation 10. θ₁, θ₂, θ₃, and θ₄ can be determined trigonometrically as shown in Equations 11, 12, 13, and 14, respectively.

$$\frac{2 π}{F} = {θ}_{1} + {θ}_{2} + {θ}_{3} + {θ}_{4} \qquad Equation 10$$

$${θ}_{1} = \frac{{J}_{L 1} + {J}_{L 4}}{M} \qquad Equation 11$$

$${θ}_{2} = {tan}^{- 1} ( \frac{M}{{J}_{L 1}} ) + {tan}^{- 1} ( \frac{1 - M}{{J}_{L 2}} ) \qquad Equation 12$$

$${θ}_{3} = \frac{{J}_{L 2} + {J}_{L 3}}{1 - M} \qquad Equation 13$$

$${θ}_{4} = {tan}^{- 1} \frac{1 - M}{{J}_{L 3}} + {tan}^{- 1} \frac{M}{{J}_{L 4}} \qquad Equation 14$$

The arcs between J_{L1} and J_{L2}, and between J_{L3} and J_{L4}, are circular, so that J_{L1} and J_{L2} are equal radii of a first circle, and J_{L3} and J_{L4} are equal radii of a second circle. Normalized currents J_{L1}, J_{L2}, J_{L3}, and J_{L4} and can be determined trigonometrically as shown in Equations 15 and 16. J_{L} is determined, as shown in Equation 17, by taking the integral of the current (I_{L}) through the first inductor 120 over one switching cycle and normalizing the result.

$${J}_{L 1}^{2} = ( 1 - 2 M ) + {J}_{L 2}^{2} \qquad Equation 15$$

$${J}_{L 4}^{2} = ( 1 - 2 M ) + {J}_{L 3}^{2} \qquad Equation 16$$

$${J}_{L} = ( \frac{F}{2 π} ) ( ( \frac{{J}_{L 1} - {J}_{L 4}}{2} ) {θ}_{1} + ( \frac{{J}_{L 2} - {J}_{L 3}}{2} ) {θ}_{3} ) \qquad Equation 17$$

Equations 10 through 17 provide eight equations with eleven variables: J_{L1}, J_{L2}, J_{L3}, J_{L4}, θ₁, θ₂, θ₃, θ₄, M, F, and J_{L}. Solving for these eleven variables enables deterministic, improved (or optimized) control of the first phase circuit 114, and responsively, the second phase circuit 116. For example, θ₁, θ₂, θ₃, and θ₄ can be used to determine on-off timing for MN1 122 and MN2 124. In some examples, the above-described equations can be solved for the second phase circuit 116 using corresponding signal measurements provided by the signal sensor 106.

Three of the variables can be fixed, or treated as inputs. In some examples, input variables are determined according to design rules, and/or are measured or determination is enabled by signals provided by the signal sensor 106, and/or are determined by the control IC 108 responsive to measurement.

J_{LR} is a compensation parameter, generated from measurements, which is used to keep V_{OUT} at the regulated voltage level within designed tolerances. J_{LR} can also be described as a normalized current reference for a power factor control loop. In an example, J_{LR} is determined as a current reference divided by I_{base}. In another example, J_{LR} is determined as an output of a voltage loop compensator multiplied by a measured value of V_{IN} and divided by the square of a root-mean-squared (RMS) value of V_{IN} (V_{IN_RMS}²). The voltage loop compensator is a proportional-integral (PI) compensator that monitors V_{OUT}. Responsive to J_{LR}, the control IC 108 determines a target amount of power for the converter to be controlled to deliver to keep V_{OUT} at the regulated value. Note that J_{LR} is used below in Equation 19.

Example input variables or values that enable determination of input variables include: mean value of inductor current I_{L} or normalized inductor current J_{L}, peak current ILI before turning off the control switch (such as MN1 122), normalized frequency F, one or more of the values used to determine normalization values (Equations 1 through 9), or J_{LR}. Accordingly, the system of control equations corresponding to Equations 10 through 17 can be solved. In some examples, J_{L1}, J_{L2}, J_{L3}, J_{L4}, M, F, and J_{L} are intermediate values used to determine θ₁, θ₂, θ₃, θ₄, which correspond to switch on-off control timings.

In some examples, Equations 10 to 17 are a transcendental set of equations. In some examples, solving the control equations uses an iterative numerical method that is computation-expensive. In some examples, using the numerical method to reach a designed control accuracy prevents real-time converter control. Equations 19 through 26 enable simplification of the set of control equations to facilitate and/or enable more precise (or precise) real-time solution and corresponding control of the boost converter 102 or other ZVS-QSW converter.

Equations 15 and 17 are rewritten as shown in Equations 19 and 20. For example, Equation 19 is determined by using Equations 11, 13, 15, 16, and 25 (described below) to perform a series of substitutions into Equation 17. Note that solving Equation 19 to determine J_{L1} enables solving Equation 20 to determine J_{L2}.

$${J}_{L 1} = \sqrt{{( 1 - M )}^{2} + \frac{4 ( ( 1 - M ) M π {J}_{LR} )}{F}} \qquad Equation 19$$

$${J}_{L 2} = \sqrt{- 1 + 2 M + {J}_{L 1}^{2}} \qquad Equation 20$$

Equation 21 provides a trigonometric identity which enables Equation 14 to be simplified:

$$\frac{π}{2} = {tan}^{- 1} x + {tan}^{- 1} \frac{1}{x} \qquad Equation 21$$

In some examples, π/2 is a reasonable allocation of a portion of the first phase circuit 114 switching period to t4 216, because during t4 216 negative current I_{L} is relatively small. Accordingly, it takes a relatively long time for the current through the first inductor 120 to discharge parasitic capacitances of MN1 122. As described above, θ₄ corresponds to t4 216. Accordingly, in light of Equations 14 and 21, θ₄ can be set as shown in Equation 22.

$${θ}_{4} = \frac{π}{2} \qquad Equation 22$$

Further, a J_{L3} term in Equation 17 can be described as x in Equation 21, and a J_{L4} term in Equation 17 can be described as 1/x in Equation 21. Accordingly, J_{L3} and J_{L4} are related as shown in Equation 23.

$${J}_{L 3} = \frac{M ( 1 - M )}{{J}_{L 4}} \qquad Equation 23$$

In light of Equation 23, J_{L3} and J_{L4} can be selected as described by Equations 24 and 25. As shown in Equations 24 and 25, J_{L3} and J_{L4} are dependent on the ratio M between input and output voltages, and are independent of switch timing or a mean value of inductor current.

$${J}_{L 3} = M \qquad Equation 24$$

$${J}_{L 4} = 1 - M \qquad Equation 25$$

A normalized angle θ_{3,ext} corresponds to the portion of t3 214 after J_{L} falls below zero (an “extra” duration in t3). Accordingly, θ_{3,ext} begins in response to ZCD 236 through MN1 122, and specifies when MN1 122 should be turned off so that t4 216 begins. In some examples, using θ_{3,ext} instead of θ₃ simplifies the set of control equations and improves their utility by making a switch timing more explicitly responsive to a measurement by the signal sensor 106. θ_{3,ext} is given by Equation 26:

$${θ}_{3 , ext} = \frac{{J}_{L 3}}{1 - M} \qquad Equation 26$$

Responsive to some or all of Equations 1 through 9, Equations 11, 12, 19, 20, 22, 24, 25, and 26 can be sequentially processed (such as in a sequence responsive to the variables selected as fixed, or input variables) to determine values enabling boost converter 102 control. As described above, such values include, for example, J_{L1}, J_{L2}, J_{L3}, J_{L4}, θ₁, θ₂, θ₃, θ₄, M, F, and J_{L}. This can be done in real time to enable more precise (or precise) real-time control of the boost converter 102. In some example, different variables, and/or different equations, and/or different combinations of the equations described above, can be used to enable such precise real-time control.

Measurement delay may introduce error into determination of control parameters for the boost converter 102 according to the above-described equations. One or more process stages such as measurement, signal processing, or control signal generation may introduce delay from a measured event or value to a responsive control signal reaching controlled components such as switches. Apparatus and/or process approaches to correcting for such error responsive to ZCD events is described with respect to FIGS. 4 and 5. Apparatus and/or process approaches to correcting for such error responsive to input voltage measurement is described with respect to FIGS. 7, 8, and 9.

In some examples, one set of determined values of θ₁, θ₂, θ₃, and θ₄ is applied to determination of switch on-off timing for all phase circuits in a power converter. In some examples, certain adjustment factors, such as those described with respect to FIGS. 4 and 5, are applied independently with respect to each phase circuit to determine corresponding switch on-off timings.

FIG. 3B is a set of tables 314 showing equations described with respect to FIG. 3A, enabling example control of the boost converter system 100 of FIG. 1A. The tables 314 include a first table 316 showing Equations 1 through 9, and a second table 318 showing Equations 11, 12, 19, 20, 22, 24, 25, and 26.

FIG. 4 is a functional block diagram of an example of the PTA (phase timing adjustment) module 141 of FIG. 1A. For a power converter that includes a number N phase circuits, the PTA module 141 includes N minus one PTA circuits 402. A first PTA circuit 402-1 provides a first phase delay timing adjustment value to adjust a phase delay of second phase circuit PWM control signals with respect to first phase circuit PWM control signals. A second PTA circuit 402-2 provides a second phase delay timing adjustment value to adjust a phase delay of third phase circuit PWM control signals with respect to the first phase circuit PWM control signals. And so on, so that an (N−1)^{th} PTA circuit 402-(N−1) provides an (N−1)^{th} phase delay timing adjustment value to adjust a phase delay of N^{th} phase circuit PWM control signals with respect to the first phase circuit PWM control signals. Accordingly, a number S^{th} phase circuit (such as the second phase circuit 116) corresponds to an (S−1)^{th} PTA circuit 402-(S−1) (such as the first PTA circuit 402-1).

The PTA circuits 402 each include a division block 404, an addition block 406, a PI compensator 408, a first multiplier 410, and a second multiplier 412. A first input of the division block 404 receives a phase delay measurement, and a second input of the division block receives a period measurement referred to as T. The phase delay measurement is referred to as φ_{S}, where S is the number of the corresponding phase circuit. In some examples, φ_{M} and T are binary values representing corresponding durations as fractional seconds.

The division block 404 provides φ_{S}/T to an inverting input of the addition block 406. φ_{S}/T represents a fraction of a switching control period corresponding to the measured phase delay, and can be described as a normalized phase delay. A noninverting input of the addition block 406 receives S/N, which represents a designed portion of the switching control period corresponding to the measured phase delay. S/N can be described as the reference for the PI compensator 408. The addition block 406 provides S/N−φ_{S}/T to a first input of the PI compensator 408. S/N−φ_{S}/T can be described as a phase delay error.

K_{P,N} is a normalized proportional PI compensator gain. Kix is a normalized integral PI compensator gain. In some examples, K_{P,N} and K_{I,N} are determined at the design level, such as by calculation or simulation, or responsive to testing of a sample device.

A first input of the first multiplier 410 receives K_{P,N}. A second input of the first multiplier 410 receives T. The first multiplier 410 scales K_{P,N} by multiplying it by T, and provides K_{P,N}×T=K_{P} to a second input of the PI compensator 408. K_{P} is a proportional compensator gain. A first input of the second multiplier 412 receives K_{I,N}. A second input of the second multiplier 412 receives T. The second multiplier 412 scales K_{I,N} by multiplying it by T, and provides K_{I,N}×T=K_{I} to a third input of the PI compensator 408. K_{I} is an integral PI compensator gain. Each PI compensator 408 outputs a phase delay timing adjustment value t_{φ,S} (a duration responsive to φ_{S} and applicable to the S^{th} phase circuit) for use by the PWM module 132 to determine a phase delay and corresponding switch control signal timings. Generation of t_{φ,S}, and use of t_{φ,S} to determine switch control signal timings, is further described with respect to FIG. 5.

In an example, the addition block 406, together with the PI compensator 408, can be described as an error amplifier. In some examples, this error amplifier can be implemented using an operational amplifier (op-amp).

FIG. 5 is a process flow diagram of an example process 500 for generating a phase delay timing adjustment value using the PTA module 141 of FIGS. 1 and 4.

In step 502, a phase delay t_{φ,S} and period T is measured for an S^{th} phase circuit (such as the second phase circuit 116) with respect to the first phase circuit (such as the first phase circuit 114). In an example, step 502 may be performed by capturing a digital or analog measure of a delay duration between a falling (or rising) edge of a first phase circuit PWM control signal (or other control-responsive first phase circuit signal) and a rising (or falling) edge of an S^{th} phase circuit PWM control signal (or other control-responsive S^{th} phase circuit signal that matches the measured first phase circuit signal). Measured PWM control signals may correspond to, for example, signals provided by the PWM module 132 or by the gate driver 110.

Recall that for N total phase circuits, PWM control signals for an S^{th} phase circuit should be phase delayed from PWM control signals for a first phase circuit by (S−1)*(360 degrees)/N. Accordingly, in an example, PWM control signals for MN3 128 and MN4 130 should be phase delayed from PWM control signals for MN1 122 and MN2 124 by 180 degrees.

In step 504, a normalized phase delay t_{φ,S}/T is determined. In step 506, proportional and integral compensator gains K_{P,N} and K_{I,N} are scaled (e.g., multiplied) by the period T to generate K_{P} and K_{I}. In step 508, determine the phase delay timing adjustment value t_{φ,S} for the S^{th} phase circuit responsive to a difference between a designed phase delay (S/N) and the normalized phase delay, and responsive to the compensator gains K_{P} and K_{I}. In step 510, one or more switch timing parameters are adjusted responsive to t_{φ,S}, and the power converter (such as the boost converter 102) is controlled using the adjusted timing parameters. For example, timing parameters corresponding to θ₁, θ₂, θ₃, θ₄, and/or t1, t2, t3, or t4, and/or other switch timing parameters described below (e.g., t_{cf} and/or t_{sr,ext}).

In some examples, adjusting a duration (tef, corresponding to θ₁) in a switch control period during which a control switch (such as MN2 124 or MN4 130) is turned on can be used to correct a phase delay error. The phase delay error equals S/N−φ_{S}/T. In some examples, adjusting a synchronous rectifier post-ZCD on-duration (t_{sr,ext}, corresponding to θ_{3,ext}) can be used to compensate for the adjusted ter on-time. In some examples, adjusting t_{sr,ext} with tef adjusts an average current through an inductor 120 and/or 126 to enable accurate interleaving and current balance.

In some examples, the variables determined in Equations 1 through 9 are assumed to be the same across the set of phase circuits in the multiphase power converter. Herein, t_{cf} and t_{sr,ext} are common durations determined using these values (such as R₀, V_{base}, I_{base}, F, M, and ω₀). Example phase delay correction options are provided according to a two phase power converter. Similar approaches may be used for a more-than-two phase power converter.

A first example corrects phase delay by setting a first phase circuit control switch on-state duration (t_{cf,1}) and a second phase circuit control switch on-duration (t_{cf,2}), as shown in Equations 27 and 28.

$${t}_{cf , 1} = {t}_{cf} \qquad Equation 27$$

$${t}_{cf , 2} = {t}_{cf} + {t}_{φ , S} \qquad Equation 28$$

A second example corrects phase delay by setting a t_{cf,1} and t_{cf,2}, as shown in Equations 29 and 30.

$${t}_{cf , 1} = {t}_{cf} - \frac{{t}_{φ , S}}{2} \qquad Equation 29$$

$${t}_{cf , 2} = {t}_{cf} + \frac{{t}_{φ , S}}{2} \qquad Equation 30$$

A third example corrects phase delay and current balance responsive to t_{φ,S}<0. Values of t_{cf,1}, t_{cf,2}, a first phase circuit synchronous rectifier post-ZCD on-state duration (t_{sr,ext,1}), and a second phase circuit synchronous rectifier post-ZCD on-state duration (t_{sr,ext,2}) are determined as shown in Equations 31, 32, 33, and 34. Values of t_{cf,1}, t_{cf,2}, t_{sr,ext,1}, and t_{sr,ext,2} are adjusted, responsive to t_{φ,S}<0, to increase an average current in the first phase circuit to equal average current in the second phase circuit. In some examples, the t_{φ,S} factor can be described as adjusting for an increase (or decrease) in current through an S^{th} phase inductor due to a longer (or shorter) tef by decreasing (or increasing) the current through the S^{th} phase inductor by the same amount. Equations 31, 32, 33, and 34 follow:

$${t}_{cf , 1} = {t}_{cf} - \frac{{t}_{φ , S}}{2} \qquad Equation 31$$

$${t}_{sr , ext , 1} = {t}_{sr , ext} - \frac{{t}_{φ , S}}{2} \times \frac{M}{M - 1} \qquad Equation 32$$

$${t}_{cf , 2} = {t}_{cf} \qquad Equation 33$$

$${t}_{sr , ext , 2} = {t}_{sr , ext} \qquad Equation 34$$

A fourth example corrects phase delay and current balance responsive to t_{φ,S}>0. Values of t_{cf,1}, t_{cf,2}, t_{sr,ext,1}, and t_{sr,ext,2} are determined, responsive to t_{φ,S}>0, to decrease an average current in the second phase circuit to equal average current in the first phase circuit. Values of t_{cf,1}, t_{cf,2}, t_{sr,ext,1}, and t_{sr,ext,2} are determined as shown in Equations 35, 36, 37, and 38.

$${t}_{cf , 1} = {t}_{cf} \qquad Equation 35$$

$${t}_{sr , ext , 1} = {t}_{sr , ext} \qquad Equation 36$$

$${t}_{cf , 2} = {t}_{cf} + \frac{{t}_{φ , S}}{2} \qquad Equation 37$$

$${t}_{sr , ext , 2} = {t}_{sr , ext} + \frac{{t}_{φ , S}}{2} \times \frac{M}{M - 1} \qquad Equation 38$$

A fourth example corrects phase delay and current balance responsive to t_{φ,S}<0. A current share adjustment term for an S^{th} phase circuit as (alpha-sub-S) is used to correct relatively larger errors in current sharing than are addressed by adjustment of control FET on-state duration using t_{φ,S}. The as term can be used to reduce an average current in a phase circuit that is carrying excess current, or to increase an average current in a phase circuit that is carrying too little current.

In some examples, the value of as is determined using a PI compensator. A first input of the PI compensator receives a difference between a current through a first phase inductor (such as the first inductor 120) and a current through an S^{th} phase inductor (such as the second inductor 126). The current through the first phase inductor can be described as a reference for the PI compensator. A second input of the PI compensator receives a proportional gain (similar to K_{P}), and a third input of the PI compensator receives an integral gain (similar to K_{I}). The proportional and input gain values are determined at the design level, such as by calculation or simulation, or responsive to testing of a sample device. The output of the PI compensator is as.

Values of t_{cf,1}, t_{cf,2}, t_{sr,ext,1}, and t_{sr,ext,2} are determined, responsive to t_{φ,S}<0, to increase an average current in the first phase circuit to equal average current in the second phase circuit. Values of t_{cf,1}, t_{cf,2}, t_{sr,ext,1}, and t_{sr,ext,2} are determined as shown in Equations 39, 40, 41, and 42.

$${t}_{cf , 1} = {t}_{cf} - \frac{{t}_{φ , S}}{2} \qquad Equation 39$$

$${t}_{sr , ext , 1} = {t}_{sr , ext} - \frac{{t}_{φ , S}}{2} \times \frac{M}{M - 1} \times {α}_{S} \qquad Equation 40$$

$${t}_{cf , 2} = {t}_{cf} \qquad Equation 41$$

$${t}_{sr , ext , 2} = {t}_{sr , ext} \qquad Equation 42$$

A fifth example corrects phase delay and current balance responsive to t_{φ,S}>0. Values of t_{cf,1}, t_{cf,2}, t_{sr,ext,1}, and t_{sr,ext,2} are determined, responsive to t_{φ,S}>0, to decrease an average current in the second phase circuit to match average current in the first phase circuit. Values of t_{cf,1}, t_{cf,2}, t_{sr,ext,1}, and t_{sr,ext,2} are determined as shown in Equations 43, 44, 45, and 46.

$${t}_{cf , 1} = {t}_{cf} \qquad Equation 43$$

$${t}_{sr , ext , 1} = {t}_{sr , ext} \qquad Equation 44$$

$${t}_{cf , 2} = {t}_{cf} + \frac{{t}_{φ , S}}{2} \qquad Equation 45$$

$${t}_{sr , ext , 2} = {t}_{sr , ext} + \frac{{t}_{φ , S}}{2} \times \frac{M}{M - 1} \times {α}_{S} \qquad Equation 46$$

A sixth example corrects phase delay be adjusting the phase time constant (\sqrt{LC}), such as by adjusting the value of L that is used in calculations with respect to one or more of the phase circuits. For example, decreasing L will increase a frequency of a corresponding phase circuit, and increasing L will decrease the frequency of the corresponding phase circuit. In an example, L is adjusted at the ISR refresh rate. In some examples, adjusting L reduces current imbalance related to L/C mismatch.

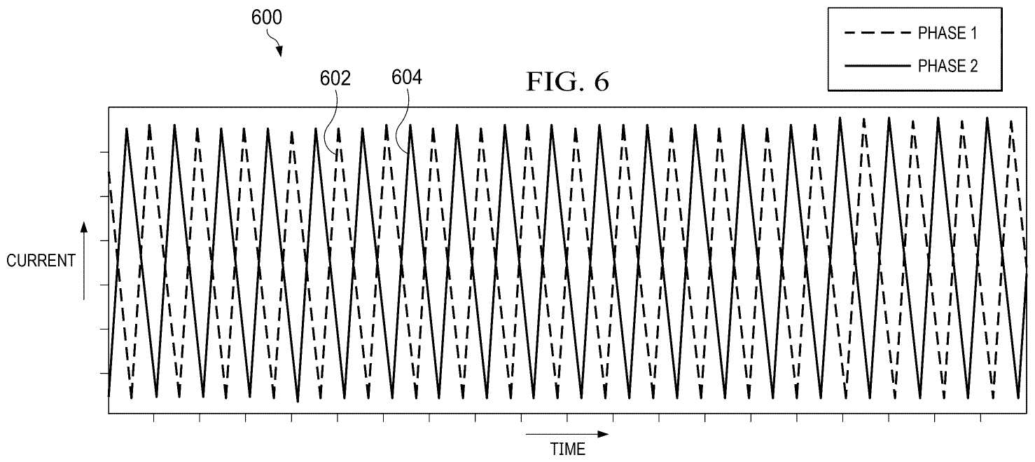

FIG. 6 is a graph 600 of example inductor current against time for the boost converter system 100 of FIG. 1A, responsive to phase timing adjustment as described with respect to FIGS. 4 and 5. A horizontal axis of the graph 600 indicates time. A vertical axis of the graph 600 indicates current. The graph 600 includes a first inductor current curve 602 and a second inductor current curve 604. Following application of phase time adjustment as described with respect to FIGS. 4 and 5, the first and second inductor current curves 602 and 604 are approximately 180 degrees (π radians) out of phase with each other. Also, sequentially successive peak and average first and second inductor currents 602 and 604 approximately equal each other. These characteristics facilitate benefits including system stability, improved efficiency, and/or reduced harmonics.

FIG. 7 is a graph 700 of example signals of the boost converter system 100 of FIG. 1A, responsive to delay corresponding to a signal path from input voltage measurement by the signal sensor 106 to use of control signals responsive to the input voltage measurement. A horizontal axis of the graph 700 indicates time. A vertical axis of the graph 700 indicates voltage. The graph 700 includes an actual V_{IN} curve 702, a measured V_{IN} curve 704, a correction signal curve 706, and a compensated V_{IN} curve 708.

The actual V_{IN} curve 702 corresponds to a value of V_{IN} at a time t_{MEAS}, when a process to measure V_{IN}, such as a signal controlling a measurement component to capture an instantaneous V_{IN}, is controlled to occur. Accordingly, t_{MEAS} is a time designed to correspond to the measured value of V_{IN}, and other parameters used to determine switch on-off timing can be determined against the same t_{MEAS}. However, various delay durations are introduced from t_{MEAS} to processing (“observation”) by the processor 134 of the measured value of V_{IN} to generate responsive switch control signals to control terminals of responsively controlled switches (such as gates of MN1 122, MN2 124, MN3 128, or MN4 130). Accordingly, there is some time taken (delay) to perform the measurement, there is delay introduced by sampling (or filtering) the measurement signal, and there is additional delay contributed in processing the sampled measurement signal to generate switch control signals. This delay can also be described as delay from the input on the power lines to the “observed” input.

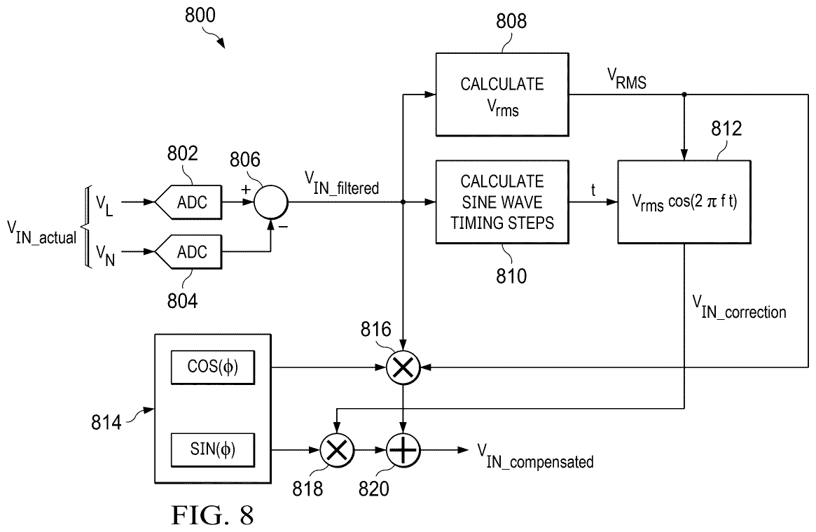

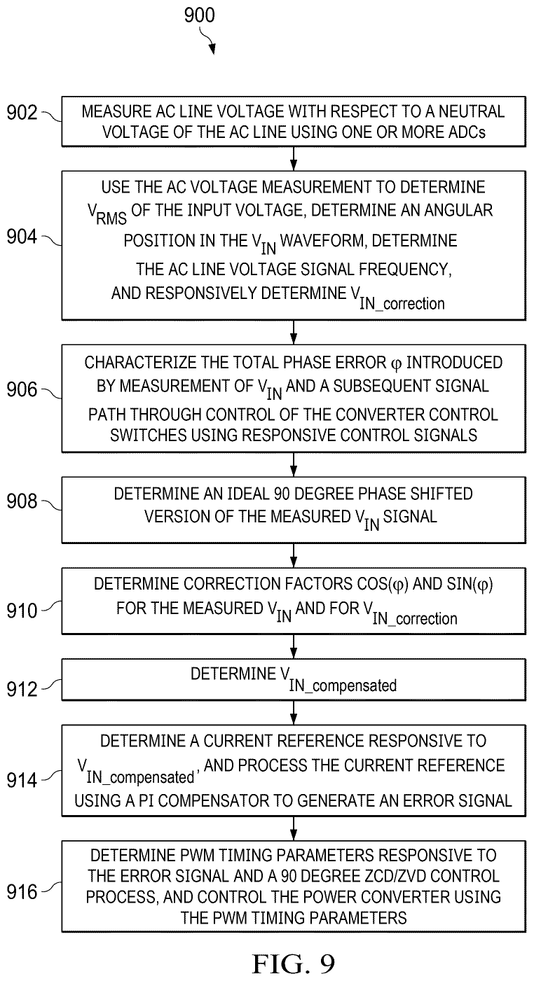

As discussed above with respect to FIGS. 3A and 3B, V_{IN} is used to determine (for example) normalized input voltage M (Equation 7), which is used throughout the system of control equations. Measurement and signal path delay affecting V_{IN} corresponds to a delay in the V_{IN} waveform. The delayed V_{IN} waveform corresponds to the measured V_{IN} curve 704. In an example, at time t 710, the actual V_{IN} curve 702 has a first voltage value 712, and the measured V_{IN} curve 704 has a second voltage value 714. A correction signal 706 can be applied to the measured V_{IN} curve 704, as further described with respect to FIGS. 8 and 9, to determine the compensated V_{IN} curve 708. The compensated V_{IN} curve 708 is nearly equal to the actual V_{IN} curve 702.

FIG. 8 is a functional block diagram of a compensation module 800 for correcting a measured input voltage for measurement and/or signal path delay. In some examples, the compensation module 800 in the signal sensor 106, or is included in the processor 134 or is otherwise part of the control IC 108. The compensation module 800 includes a first analog-to-digital converter (ADC) 802, a second ADC 804, a first adder 806, a V_{RMS} block 808, a timing block 810, a correction signal block 812, a correction factor block 814, a first multiplier 816, a second multiplier 818, and a second adder 820.

The first ADC 802 receives and samples a line voltage signal V_{L} of an AC voltage source. The second ADC 804 receives and samples a neutral voltage signal V_{N}, such as a zero or ground voltage, of the AC voltage source. The voltage signal V_{IN_actual} of the AC voltage source can be described as shown in Equation 47, in which V_{RMS} in a root-mean-square voltage of the AC voltage source, t is a time at which V_{IN} is measured, and ω is the angular frequency of the line voltage. In some examples, w is 50 to 60 Hertz. In some examples, an exact value of ω is unnecessary, due to the relatively small amplitude of the compensation signal.

$${V}_{IN \_ actual} = \sqrt{2} {V}_{RMS} sin ( t ω ) \qquad Equation 47$$

A noninverting input of the first adder 806 receives the digitized sampled V_{L}, and an inverting input of the first adder 806 receives the digitized sampled V_{N}. An error factor φ_{fil} represents the phase shift introduced by measuring/sampling (filtering) the V_{IN} signal, such as by processing the V_{L} and V_{N} signals using the first and second ADCs 802 and 804. The first adder 806 generates a measured V_{IN} value V_{IN} measured as a difference between V_{L} and V_{N}, which can be described as shown in Equation 48.

$${V}_{IN \_ measured} = \sqrt{2} {V}_{RMS} sin ( t ω - {φ}_{fil} ) \qquad Equation 48$$

The first adder 806 provides the measured V_{IN} value to inputs of the V_{RMS} block 808 and the timing block 810, and to a first input of the first multiplier 816. The V_{RMS} block 808 determines V_{RMS} responsive to the measured V_{IN} value, such as using an infinite impulse response (IIR) filter or on a line cycle basis. In an example, line cycle basis corresponds to determining when a period of the source voltage waveform begins and ends, and determining an RMS average of the source voltage over one period. The V_{RMS} block 808 provides V_{RMS} to a first input of the correction signal block 812 and a second input of the first multiplier 816.

The timing block 810 maintains a timer, such as a counter, that tracks a time t. The timer is reset responsive to a zero crossing of the measured V_{IN}. In some examples, the timer is reset at a positive zero crossing of the measured V_{IN} (transitioning from a negative V_{IN} to a positive V_{IN}). In some examples, the timer is set to a value corresponding to a half switching cycle (switching period T) responsive to a negative zero crossing of the measured V_{IN} (transitioning from a positive V_{IN} to a negative V_{IN}). Responsive to the switch control ISR iteratively executing, the timer increments by a step corresponding to a duration of execution of the switch control ISR. The timing block 810 provides t to the correction signal block 812. The time t is used to determine an angular position (to) of the measured V_{IN} within the V_{IN} signal.

The correction signal block 812 generates a signal V_{IN_correction} used to correct the measured V_{IN}. This signal is shown in Equation 49, in which ω is the AC line frequency of the V_{IN} waveform. In some examples, ω is provided, or is determined responsive to measurement or a control signal that sets ω.

$${V}_{IN \_ correction} = \sqrt{2} {V}_{RMS} sin ( t ω - {φ}_{fil} ) \qquad Equation 49$$

The correction signal block 812 provides V_{IN_correction} to a first input of the second multiplier 818. A correction factor q is determined at the design level, such as by calculation or simulation, or responsive to testing of a sample device. The correction factor φ equals (or represents) a phase correction that will shift the observed input signal (the measured V_{IN} value) to align with the actual V_{IN} input signal. The correction factor φ is used to compensate for the delay sources that cause V_{IN} measurement-related error as described above. An additional error term φₑᵣᵣ represents error in the measured V_{IN} signal not accounted for by φ_{fil}. The correction factor block 814 provides cos (ω) to a third input of the first multiplier 816, and provides sin (q) to a second input of the second multiplier 818. The first multiplier 816 outputs to a first input of the second adder 820, and the second multiplier 818 outputs to a second input of the second adder 820. Accordingly, the second adder 820 outputs a corrected measured V_{IN} signal V_{IN_compensated}, which is described in Equation 50.

$${V}_{IN \_ compensated} = \sqrt{2} {V}_{RMS} ( sin ( φ ) cos ( t ω - {φ}_{fil} - {φ}_{err} ) + cos ( φ ) sin ( t ω - {φ}_{fil} ) ) \qquad Equation 50$$

V_{IN_compensated} is used in the equations described with respect to FIG. 3A to more accurately determine θ₁, θ₂, θ₃, θ₄, and responsively, to determine more accurate on-off control timing for the switches 122, 124, 128, and/or 130. In some examples, V_{IN_compensated} is used to determine the current reference J_{LR} (described above with respect to Equation 19) and in a 90 degree ZCD/ZVD (zero voltage detection) control process. 90 degrees refers to setting θ₄ to equal π/2 (Equation 22). Accordingly, the control process described above with respect to Equations 1 through 26 is an example of a 90 degree ZCD/ZVD control process. In some examples, J_{LR} is determined as shown in Equation 51, in which P_{cmd} is a designed/determined power level to deliver, responsive to V_{OUT}, to adjust V_{OUT} to the regulated voltage:

$${J}_{LR} = \frac{{P}_{cmd}}{{V}_{rms}^{2}} {V}_{IN \_ compensated} \qquad Equation 51$$

Accordingly, correction of measured V_{IN} as described above enables some or all of various benefits, including higher efficiency, reduced harmonics, improved signal shaping, and improved system stability.

FIG. 9 is a process flow diagram of an example process 900 for correcting a measured input voltage value responsive to measurement and signal path delay, as described with respect to FIG. 8. In step 902, an AC line voltage is measured with respect to a neutral voltage of the AC line using one or more ADCs. In step 904, the AC voltage measurement is used to determine V_{RMS} of the input voltage, an angular position in the V_{IN} waveform is determined, the AC line voltage signal frequency is determined, and responsively, V_{IN} correction is determined (Equation 49). In step 906, the total phase error φ introduced by measurement of V_{IN} and a subsequent signal path through control of the converter control switches (e.g., the switches 122, 124, 128, and/or 130) using control signals responsive to measured V_{IN} is characterized.

In step 908, an ideal 90 degree phase shifted version of the measured V_{IN} signal is determined. In step 910, correction factors cos (+) and sin (ω) for the measured V_{IN} and for V_{IN_correction} are determined. In step 912, V_{IN_compensated} responsive to cos (Q), sin (p), and V_{IN_correction} (Equation 50) are determined. In step 914, a current reference responsive to V_{IN_compensated} (Equation 51) is determined, and the current reference is compared to sensed inductor current (such as total current through the first and second inductors 120 and 126) using a PI compensator (or other digital compensator) to generate a compensated error signal. A compensated error represented by the compensated error signal is added to a control switch on-time (tef) to generate a compensated control switch on-time. The control switch (e.g., MN1 122 or MN3 128, depending on which half-period the V_{IN} signal is in) is controlled responsive to the compensated control switch on-time. In step 916, determine PWM timing parameters responsive to the compensated error signal and the 90 degree ZCD/ZVD control process, and control the power converter using the PWM timing parameters.

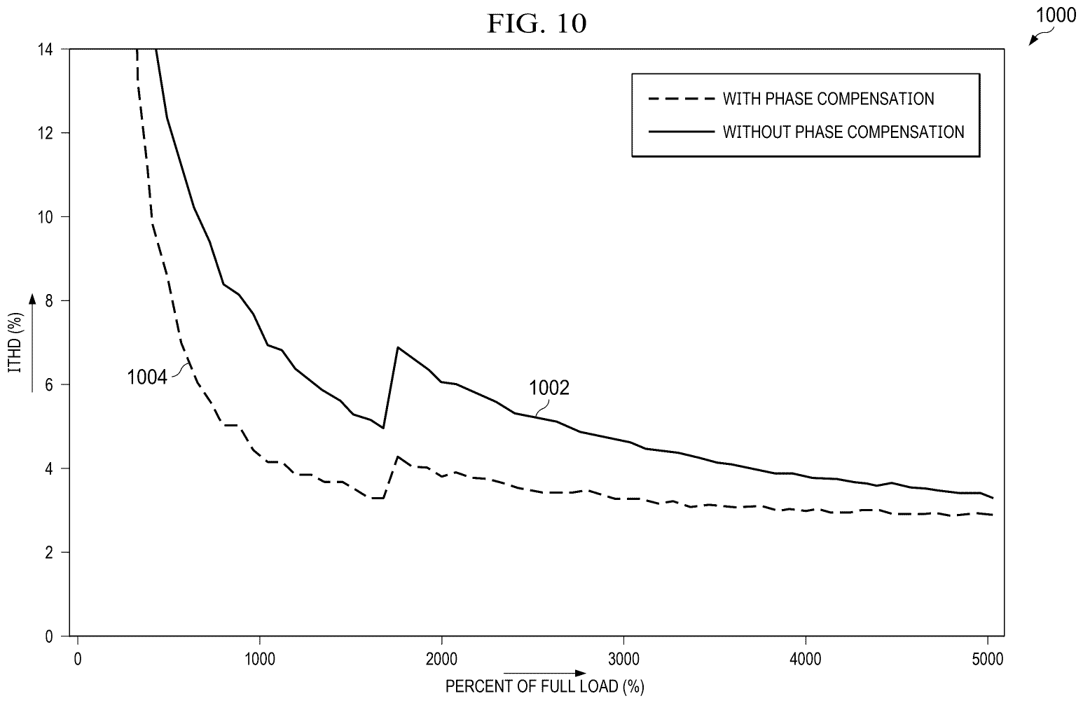

FIG. 10 is a graph 1000 of total harmonic distortion (iTHD) in an output signal against load in the boost converter system 100 of FIG. 1A. A horizontal axis of the graph 1000 indicates a load (a power level) of the power converter. A vertical axis of the graph 1000 indicates total harmonic distortion. The graph includes a total harmonic distortion without V_{IN} phase compensation curve 1002, and a total harmonic distortion with V_{IN} phase compensation curve 1004. There is more total harmonic distortion in the no phase compensation curve 1002, across all load levels, than in the with phase compensation curve 1004.

Modifications are possible in the described examples, and other examples are possible, within the scope of the claims.

In some examples, system design aspects and processes described herein can be used with or adapted to ZVS-QSW converters other than AC-DC converters, such as AC-AC converters or DC-DC converters.

In some examples, the control circuits and processes described herein can be used to control multiple phase PWM-controlled devices with more than one phase, accordingly, two or more phases.

In some examples, determinations described herein as being performed during device design can be performed during device testing, or at a later stage.

In some examples, the signal sensor 106 also senses temperature of the two phase boost converter 102.

In some examples, an inductor can also be described as a winding.

In some examples, one or more of MN1 122, MN2 124, MN3 128, or MN4 130 includes structure described herein as corresponding to the signal sensor 106.

In some examples, a ZVS-QSW power converter is controlled using a control process other than a 90 degree ZCD/ZVD control process.

The term “couple” is used throughout the specification. The term may cover connections, communications, or signal paths that enable a functional relationship consistent with this description. For example, if device A provides a signal to control device B to perform an action, in a first example device A is coupled to device B, or in a second example device A is coupled to device B through intervening component C if intervening component C does not substantially alter the functional relationship between device A and device B such that device B is controlled by device A via the control signal provided by device A.

In this description, the term “and/or” (when used in a form such as A, B and/or C) refers to any combination or subset of A, B, C, such as: (a) A alone; (b) B alone; (c) C alone; (d) A with B; (e) A with C; (f) B with C; and (g) A with B and with C. Also, as used herein, the phrase “at least one of A or B” (or “at least one of A and B”) refers to implementations including any of: (a) at least one A; (b) at least one B; and (c) at least one A and at least one B.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin”, “ball” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors are described herein, other transistors (or equivalent devices) may be used instead with little or no change to the remaining circuitry. For example, a MOSFET (such as an n-channel MOSFET, nMOSFET, or a p-channel MOSFET, pMOSFET), a gallium nitride field-effect transistor (GaN FET, such as an n-channel GaN FET or p-channel GaN FET), a bipolar junction transistor (BJT—e.g. NPN or PNP), insulated gate bipolar transistors (IGBTs), and/or junction field effect transistor (JFET) may be used in place of or in conjunction with the devices disclosed herein. The transistors may be depletion mode devices, drain-extended devices, enhancement mode devices, natural transistors or other type of device structure transistors. Furthermore, the devices may be implemented in/over a silicon substrate (Si), a silicon carbide substrate (SiC), a gallium nitride substrate (GaN) or a gallium arsenide substrate (GaAs).

Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples may be included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. Unless otherwise stated, “about,” “approximately,” or “substantially” preceding a value means +/−10 percent of the stated value, or, if the value is zero, a reasonable range of values around zero.

What is claimed is:

1. A device comprising:
a first inductor;
a second inductor;
a first phase switching circuit coupled to the first inductor;
a second phase switching circuit coupled to the second inductor; and
a controller coupled to the first and second phase switching circuits and the PI compensator, the controller including a proportional-integral (PI) compensator having a first input and an output, the controller configured to:
generate a phase error signal responsive to a switching period, a target phase delay of the second control signal with respect to the first control signal, and a phase difference between a first control signal corresponding to the first phase switching circuit and a second control signal corresponding to the second phase switching circuit;
provide the phase error signal to the first input of the PI compensator; and
control the first phase switching circuit in a first phase and the second phase switching circuit in a second phase, responsive to the first and second control signals and an output signal of the PI compensator.

2. The device of claim 1, wherein the target phase delay is determined responsive to a number of phases and a phase number of the second phase switching circuit.

3. The device of claim 1, wherein the PI compensator has second and third inputs, and the controller is configured to:
provide the second input of the PI compensator a proportional compensator gain value; and
provide the third input of the PI compensator an integral compensator gain value.

4. The device of claim 3, wherein the controller is configured to:
determine the proportional compensator gain value responsive to a normalized proportional compensator gain value and the switching period; and
determine the integral compensator gain value responsive to a normalized integral compensator gain value and the switching period.

5. The device of claim 1,
wherein the first control signal corresponds to switching times of the first phase switching circuit and the second control signal corresponds to switching times of the second phase switching circuit; and
wherein the controller is configured to:
compare an average current through the first phase switching circuit to an average current through the second phase switching circuit;
adjust the switching times of the first phase switching circuit or the second phase switching circuit responsive to the compare action, to provide adjusted switching times; and
control the first and second phase switching circuits responsive to the adjusted switching times.

6. The device of claim 5, wherein the controller is configured to perform the adjust action responsive to a source voltage of the device and an output voltage of the device.

7. The device of claim 1, wherein the device is a zero-voltage switching quasi-square wave power converter.

8. The device of claim 1,
further comprising a sensor having first and second inputs and an output, the output of the sensor coupled to the controller;
wherein the first and second inductors each have a terminal, the first input of the sensor coupled to the terminal of the first inductor and the second input of the sensor coupled to the terminal of the second inductor.

9. A device comprising:
a first inductor having a first terminal;
a second inductor having a first terminal;
a first phase switching circuit having a first terminal and a control terminal, the first terminal of the first phase switching circuit coupled to the first terminal of the first inductor;
a second phase switching circuit having a first terminal and a control terminal, the first terminal of the second phase switching circuit coupled to the first terminal of the second inductor; and
a controller having first, second, and third outputs, the controller including a proportional-integral (PI) compensator having a first input and an output, the first and second outputs of the controller respectively coupled to the control terminals of the first and second phase switching circuits, and the third output of the controller coupled to the first input of the PI compensator, the controller configured to:
generate a phase error signal responsive to a switching period, a target phase delay of the second control signal with respect to the first control signal, and a phase difference between a first control signal corresponding to the first phase switching circuit and a second control signal corresponding to the second phase switching circuit;
provide the phase error signal to the first input of the PI compensator; and
control the first phase switching circuit in a first phase and the second phase switching circuit in a second phase, responsive to the first and second control signals and an output signal of the PI compensator.

10. The device of claim 9, wherein the PI compensator has second and third inputs, the controller has fourth and fifth outputs respectively coupled to the second and third inputs of the PI compensator, and the controller is configured to:
provide the second input of the PI compensator a proportional compensator gain value; and
provide the third input of the PI compensator an integral compensator gain value.

11. The device of claim 10, wherein the controller is configured to:
determine the proportional compensator gain value responsive to a normalized proportional compensator gain value and the switching period; and
determine the integral compensator gain value responsive to a normalized integral compensator gain value and the switching period.

12. The device of claim 9,
wherein the first control signal corresponds to switching times of the first phase switching circuit and the second control signal corresponds to switching times of the second phase switching circuit; and
wherein the controller is configured to:
compare an average current through the first phase switching circuit to an average current through the second phase switching circuit;
adjust the switching times of the first phase switching circuit or the second phase switching circuit responsive to the compare action, to provide adjusted switching times; and
control the first and second phase switching circuits responsive to the adjusted switching times.

13. The device of claim 12, wherein the controller is configured to perform the adjust action responsive to a source voltage of the device and an output voltage of the device.

14. The device of claim 9,
further comprising a sensor having first and second inputs and an output, the output of the sensor coupled to the controller;
wherein the first and second inductors each have a second terminal, the first input of the sensor coupled to the second terminal of the first inductor and the second input of the sensor coupled to the second terminal of the second inductor.

15. A device comprising:
a sensor having an output;
a first phase switching circuit having a control terminal;
a second phase switching circuit having a control terminal;
a gate driver having an input and first and second outputs, the first and second outputs of the gate driver coupled to the control terminals of the first and second phase switching circuits, respectively; and
a controller having an input and first and second outputs, the controller including a proportional-integral (PI) compensator having a first input and an output, the input of the controller coupled to the output of the sensor, the first output of the controller coupled to the input of the gate driver, and the second output of the controller coupled to the first input of the PI compensator, the controller configured to:
generate a phase error signal responsive to a phase difference between a switching period, a target phase delay of the second control signal with respect to the first control signal, and a first control signal corresponding to the first phase switching circuit and a second control signal corresponding to the second phase switching circuit;
provide the phase error signal to the first input of the PI compensator; and
control the first phase switching circuit in a first phase and the second phase switching circuit in a second phase, responsive to the first and second control signals and an output signal of the PI compensator.

16. The device of claim 15, wherein the sensor has first and second inputs, the first and second phase switching circuits each have a respective current path, the first input of the sensor is coupled to the current path of the first phase switching circuit, and the second input of the sensor is coupled to the current path of the second phase switching circuit.

17. The device of claim 15, wherein the controller has third and fourth outputs respectively coupled to the second and third inputs of the PI compensator, and the controller is configured to:
provide the second input of the PI compensator a proportional compensator gain value; and
provide the third input of the PI compensator an integral compensator gain value.

18. The device of claim 17, wherein the controller is configured to:
determine the proportional compensator gain value responsive to a normalized proportional compensator gain value and the switching period; and
determine the integral compensator gain value responsive to a normalized integral compensator gain value and the switching period.

19. The device of claim 15,
wherein the first control signal corresponds to switching times of the first phase switching circuit and the second control signal corresponds to switching times of the second phase switching circuit; and
wherein the controller is configured to:
compare an average current through the first phase switching circuit to an average current through the second phase switching circuit;
adjust the switching times of the first phase switching circuit or the second phase switching circuit responsive to the compare action, to provide adjusted switching times; and
control the first and second phase switching circuits responsive to the adjusted switching times.

20. The device of claim 19, wherein the controller is configured to perform the adjust action responsive to a source voltage of the device and an output voltage of the device.
